(19) United States
(12) Patent Application Publication
(10) Pub. No.: US 2008/0208831 A1
(43) Pub. Date: Aug. 28, 2008

(54) CONTROLLING SEARCH INDEXING

(75) Inventors: Julia H. Farago, Seattle, WA (US); Hugh E. Williams, Redmond, WA (US); Darren A. Shakib, North Bend, WA (US); Nicholas A. Whyte, Mercer Island, WA (US); Srinath R. Aaleti, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/678,699

(22) Filed: Feb. 26, 2007

(51) Int. Cl. G06F 17/30

(52) U.S. Cl. 707/5

(57) ABSTRACT

Computer readable media, systems, and methods for controlling search indexing are described. In embodiments, a search index control instruction is received and, if permitted by the search index control instruction, content pertaining to the received instruction is indexed and presented in accordance therewith. In one embodiment, receiving the search index control instruction includes traversing the Internet with a web crawler and analyzing one or both of a robots.txt file and source code associated with a website of interest to locate instructions. Search index control instructions may include, by way of example only, exclusionary instructions (e.g., excluding specified domains from linking to portions of the content associated with a website) and modification instructions (e.g., permitting indexing and presentation of content associated with a website but only in a modified form to reduce the risk of content theft).

### BACKGROUND

The Internet provides a vast amount of resources that may be searched in a variety of ways providing an Internet user with easy access to desired information. However, the same accessibility that makes the Internet such a valuable and useful tool also creates an environment which lends itself to unauthorized copying of information. Web crawlers continuously traverse the Internet to retrieve information for the purpose of, among other things, maintaining current information in a search engine index. As the Internet continues to develop, various standards are evolving that allow owners of websites to control web crawler access to information contained within their website.

Unfortunately, a problem with the various standards that are evolving is that they provide the owner of a website (or publisher of content associated therewith) with too little flexibility. A website owner can either choose to allow a web crawler access to a particular content item, or choose to prevent the web crawler's access. This binary solution of allow versus prevent, however, has several limitations. For example, there may be a website owner who includes a number of images on a website and is offering the images for sale. The owner may desire that the images appear as a result to an image search on the Internet for advertisement purposes. The owner, however, may have reservations due to the pervasiveness of unauthorized copying on the Internet and the potentially detrimental effect copying will have on the value of his images. Because of his reservations, the owner will likely choose to disallow web crawlers from accessing images on the website and, in doing so, abstain from a potentially lucrative advertising opportunity.

### SUMMARY

Embodiments of the present invention relate to computer readable media, systems, and methods for controlling search indexing. In embodiments, a search index control instruction is received and, if permitted, content pertaining to the received instruction is indexed and presented in accordance with the instruction. Search index control instructions may include, by way of example only, exclusionary instructions (e.g., excluding specified domains from linking to portions of the content associated with a website) and modification instructions (e.g., permitting indexing and presentation of content associated with a website but only in a modified form to reduce the risk of content theft). Facilitating control of search indexing in this way permits content owners and/or publishers to exercise increased flexibility in defining access to their content thus increasing the likelihood that they will permit their content to be indexed.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing system environment suitable for use in implementing embodiments of the present invention;

FIG. 2 is a block diagram illustrating an exemplary system for controlling search indexing, in accordance with an embodiment of the present invention;

FIG. 3 is a flow diagram illustrating an exemplary method for controlling search indexing utilizing a search index control instruction, in accordance with an embodiment of the present invention;

FIG. 4 is a flow diagram illustrating an exemplary method for controlling search indexing and receiving one or more search index control instructions, in accordance with an embodiment of the present invention; and

FIG. 5 is a flow diagram illustrating an exemplary method for controlling search indexing and presenting content in response to a query, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computer-readable media, systems, and methods for controlling search indexing. In various embodiments, one or more search index control instructions are received and content to which such instruction(s) pertain is indexed in accordance therewith. Further, in various embodiments, the content is presented in accordance with the one or more received instructions. While embodiments discussed herein refer to accessing web pages on the Web via the Internet, it will be understood by one of ordinary skill in the art that embodiments are not limited to the Internet. For example, other embodiments may access content via a private network.

Accordingly, in one aspect, the present invention is directed to one or more computer readable media having instructions embodied thereon that, when executed, perform a method for controlling search indexing. The method includes receiving a search index control instruction, and processing website content in accordance with the search index control instruction. The method further includes determining if indexing content to which such instructions pertain is permitted. If it is determined that indexing of the content to which the search index control instruction pertains is permitted, the respective content is indexed in accordance with the instruction. If permitted, the indexed content may be presented in accordance with the appropriate search index control instruction, for instance, in response to a search query.

In another aspect, the present invention is directed to a computerized system for controlling search indexing. The system includes a receiving component configured to receive at least one search index control instruction, a determining component configured to analyze the received search index control instruction to determine if indexing of content associated therewith is permitted, an indexing component configured to index content associated with the search index control instruction if it is determined that indexing thereof is permitted, and a database for storing the indexed content in association with the received search index control instruction.

In yet another aspect, the present invention is directed to a method for controlling search indexing. The method includes receiving a search index control instruction pertaining to content associated with at least a portion of a website, determining, based upon the search index control instruction, if indexing of the content to which it pertains is permitted, and if it is determined that indexing of the content to which the received search index control instruction pertains is permitted, indexing the content in accordance with the instruction.

Having briefly described an overview of embodiments of the present invention, an exemplary operating environment is described below.

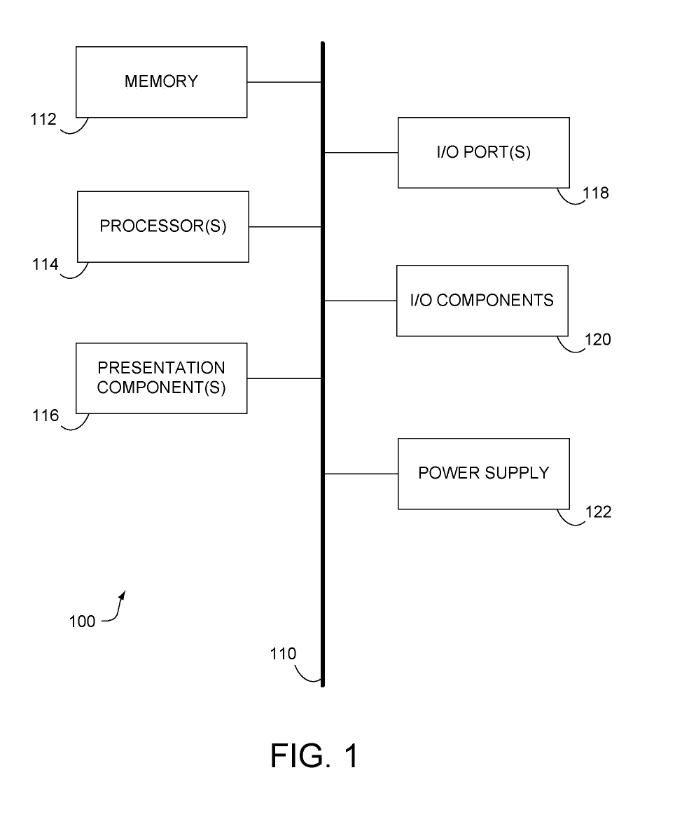

Referring to the drawing figures in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the present invention may be described in the general context of computer code or machine-usable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network. In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

Computing device 100 includes a bus 110 that directly or indirectly couples the following elements: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid state memory, hard drives, optical disc drives, and the like. Computing device 100 includes one or more processors that read from various entities such as memory 112 or I/O components 120. Presentation component(s) 116 present data indications to a user or other device. Exemplary presentation components include a display device, speaker, printing component, vibrating component, and the like.

I/O ports 118 allow computing device 100 to be logically coupled to other devices including I/O components 120, some of which may be built in. Illustrative components include a microphone, joystick, game pad, satellite dish, scanner, printer, wireless device, etc.

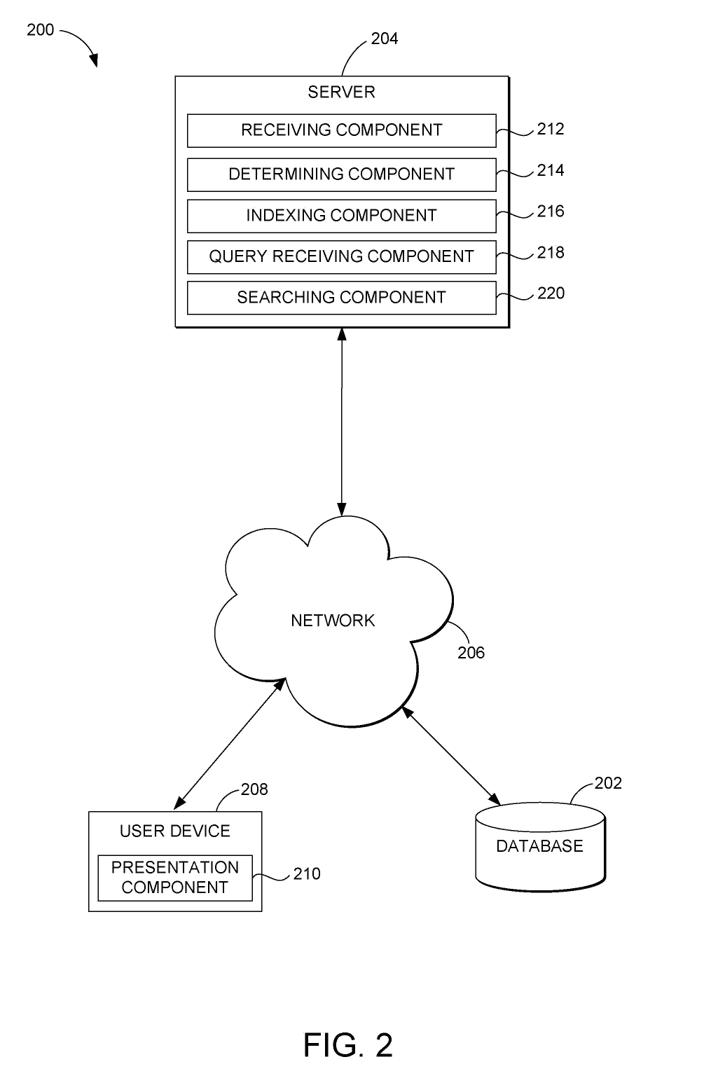

Turning now to FIG. 2, a block diagram is provided illustrating an exemplary system 200 for controlling search indexing, in accordance with an embodiment of the present invention. The system 200 includes a database 202, a server 204, and a user device 208 in communication with one another via a network 206. Network 206 may include, without limitation, one or more local area networks (LANs) and/or wide area networks (WANs). Such networking environments are commonplace in offices, enterprise-wide computer networks, intranets, and the Internet. Accordingly, network 206 is not further described herein.

Database 202 is configured to store content in accordance with at least one search index control instruction. In various embodiments, such content may include, without limitation, one or more images, one or more audio files, one or more multimedia files, other information associated with a website, and any combination thereof. Search index control instructions may include, by way of example only, one or more character strings included in a robots.txt file, one or more character strings included in source code of a website, and one or more character strings associated with shared information in a private network. In various embodiments, the database 202 is configured to be searchable for content according to the one or more index control instructions associated therewith. It will be understood and appreciated by those of ordinary skill in the art that the information stored in database 202 may be configurable and may include any information relevant to indexed content and/or search index control instructions. The content and/or volume of such information are not intended to limit the scope of embodiments of the present invention in any way. Further, though illustrated as a single, independent component, database 202 may, in fact, be a plurality of databases, for instance, a database cluster, portions of which may reside on a computing device associated with the server 204, on the user device 208, on another external computing device (not shown), or any combination thereof.

The user device 208 may be any type of computing device, such as computing device 100 described with reference to FIG. 1, for example, and includes at least one presentation component 210. The presentation component 210 is configured to present (e.g. display) content in accordance with one or more received search index control instructions pertaining thereto, as more fully described below.

The server 204 may be any type of computing device, such as computing device 100 described with reference to FIG. 1, and includes a receiving component 212, a determining component 214, an indexing component 216, a query receiving component 218, and a searching component 220. Further, the server 204 is configured to operate utilizing at least a portion of the information stored in the database 202.

The receiving component 212 is configured to receive at least one search index control instruction pertaining to content associated with a portion of a website. In various embodiments, by way of example, the receiving component 212 may receive a search index control instruction by traversing the Internet with a web crawler. In various embodiments, a web crawler may automatically traverse the hypertext structure of the Internet. For example, without limitation, in various embodiments, several algorithms may be used alone, or in combination, to optimize traversal in order to access as much of the vast information available on the Internet as possible. Web crawlers and web crawling algorithms are commonplace in various networking environments and one of ordinary skill in the art would readily understand how to apply crawling algorithms to achieve more efficient web crawling. Accordingly, web crawlers and crawling algorithms are not further discussed herein.

The receiving component 212 may further retrieve information associated with at least one website, for instance, from an associated robots.txt file, source code, or sitemap, and analyze the information to locate one or more search index control instructions. A search index control instruction embodied in a website's robots.txt file provides the owner or publisher of content associated with a portion of a website with control over how such content may be used by a search engine. A search index control instruction embodied in the source code, e.g., HTML file, associated with the website itself provides the owner or publisher of content associated with a website for which site control is not feasible (e.g., wherein one or more web pages are independently controlled) to permit access to content only in accordance with specified instruction. Further, a search index control instruction embodied in the source code for a website may permit or exclude link access to certain portions of a website independently. A search index control instruction embodied in the sitemap of a website provides the owner or publisher of content associated with a site with the ability to include an overview of content associated with the website along with exclusion and/or modification instructions with regard to each content item.

A search index control instruction may have various levels of scope as well as various functionality. In various embodiments, the search index control instruction may be a site level instruction configured to instruct the search index with regard to access to information on an entire site. For example, without limitation, a site level instruction may instruct a search index to only present a thumbnail image of every image associated with the entire site. In various other embodiments, the search index control instruction may be a page level instruction configured to instruct the search index with regard to a particular page within a website. For example, without limitation, a page level instruction may instruct a search index to only provide a short clip of every audio or multimedia file included within a single page. In yet other various embodiments, the search index control instruction may be a link level instruction configured to instruct the search index with regard to a particular link within a single page. For example, without limitation, a link level instruction may instruct a search index to only display the linked image with a border or character string superimposed over the image.

Further, in other various embodiments, the search index control instruction may be a domain instruction configured to specify one or more domains that are allowed to link to images on a particular website. For example, without limitation, msnbc.com may wish to allow msn.com to link to its images. When an Internet user searches for an image using an image search engine, an msnbc.com image appearing as a result might be associated with either msnbc.com or msn.com. If msnbc.com has provided a domain instruction included in a search index control instruction, however, the image search engine would not recognize unauthorized websites that link to an msnbc.com image. For instance, if cnn.com linked to the image without authorization in the domain instruction, the image search engine results page would not display the cnn.com link in association with an msnbc.com image.

In various embodiments, the receiving component 212 may copy information from websites accessed during web crawling and store such information, in accordance with content to which such information pertains, for instance, in database 202.

The determining component 214 is configured to determine, in accordance with the received search index control instruction(s), if indexing of the content to which such received instruction(s) pertains is permitted. Indexing of content may be permitted if no search index control instructions are associated therewith or in circumstances wherein presentation of the content is permitted in accordance with one or more search index control instructions. As more fully described below, presentation of content may be permitted in association with a search index control instruction permitting any and all websites to link thereto, permitting only specified websites to link thereto, or permitting all but one or more specified websites to link thereto. The nature and extent to which presentation is permitted is stored in association with the indexed content, e.g., in database 202, through storage of the appropriate search index control instruction(s). If it is determined by determining component 214 that indexing of the content to which a received search index control instruction pertains is not permitted, such content is not indexed or stored and, accordingly, will not be retrieved in response to a search query (as more fully described below). However, in some embodiments, the search index control instruction disallowing indexing may be stored, if desired.

The indexing component 216 is configured to index content associated with at least one received search index control instruction if it is determined (by determining component 214) that indexing of such content is permitted. Indexed content may be retrieved and presented in accordance with any associated search index control instructions, for instance, if such content is determined to satisfy a search query, as more fully described below. If it is determined by determining component 214 that indexing of the content to which a received search index control instruction pertains is not permitted, such content is not indexed or stored and, accordingly, will not be retrieved in response to a search query (as more fully described below). However, in some embodiments, the search index control instruction disallowing indexing may be stored, if desired.

The query receiving component 218 is configured to receive at least one search query, e.g., from user input received at user device 208. Upon receipt of a search query, the searching component 220 is configured to search the database for indexed content that satisfies the search query. Upon locating indexed content that satisfies the search query, the determining component 214 is further configured to determine whether, in accordance with any search index control instructions which pertain to the satisfying content, presentation of the content in response to the search query is permitted. If it is determined that presentation is not permitted, the content is disregarded as a satisfying result to the search query. If, however, it is determined that presentation is permitted, such content is presented (e.g., displayed) by presentation component 210 of the user device 208 in accordance with any search index control instructions pertaining thereto.

It will be understood and appreciated by those of ordinary skill in the art that additional components not shown may also be included within any of system 200, database 202, server 204, and user device 208. Any and all such variations, and any combinations thereof, are contemplated to be within the scope of embodiments of the present invention.

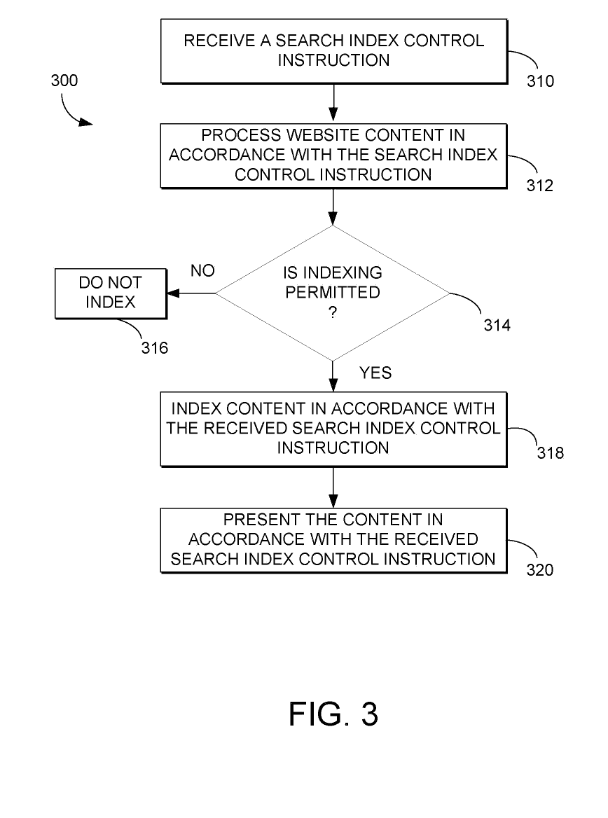

Turning now to FIG. 3, a flow diagram of an exemplary method for controlling search indexing, utilizing a search index control instruction, in accordance with an embodiment of the present invention, is illustrated and designated generally as reference numeral 300. Initially, as indicated at block 310, a search index control instruction is received, e.g., by receiving component 212 of FIG. 2. By way of example, the received instruction may be a string of characters stored in association with a website. In various embodiments, the search index control instruction may be stored in a robots.txt file. In other embodiments, the search index control instruction may be stored in the source code, e.g., the HTML code, for a website. In yet other embodiments, the search index control instruction may be stored in the sitemap of a website. Any and all such variations, and any combinations thereof, are contemplated to be within the scope of embodiments of the present invention.

Next, as indicated at block 312, website content is processed in accordance with the search index control instruction. By way of example, the search index control instruction may relate to an image within a website's content and the display of the image by other websites. In various embodiments, the image will be processed to prepare the image for indexing and modified presentation of the image, the details of which are discussed in further detail herein. In various other embodiments, processed website content may include a multimedia file, video file, an audio file, or any other information prepared for indexing and modified presentation.

Next, as indicated at block 314, it is determined if indexing of content to which the received search index control instruction pertains is permitted. If it is determined that indexing is not permitted, such content is not indexed. This is indicated at block 316. If, however, it is determined that indexing of the content to which the received search index control instruction pertains is permitted, such content is indexed (e.g., utilizing indexing component 216 of FIG. 2) in accordance with the received instruction, as indicated at block 318. As previously discussed, content may include an image, a video file, an audio file, a multimedia file, or any other information associated with a website. In various embodiments, the indexed content is actually a copy of an image, a video file, an audio file, a multimedia file, or other information, gathered from a website. Further, in various embodiments, the indexed content is stored, for instance, in a database such as database 202 of FIG. 2.

Next, as indicated at block 320, indexed content may be presented in accordance with the received search index control instruction, e.g., by presentation component 210 of FIG. 2. As previously described, various content can be presented in a number of formats in order to conform with the search index control instruction. For example, without limitation, an image may be presented with a character string superimposed over the image or with a border associated therewith. Further discussion of various presentation embodiments are included with reference to FIG. 2 above.

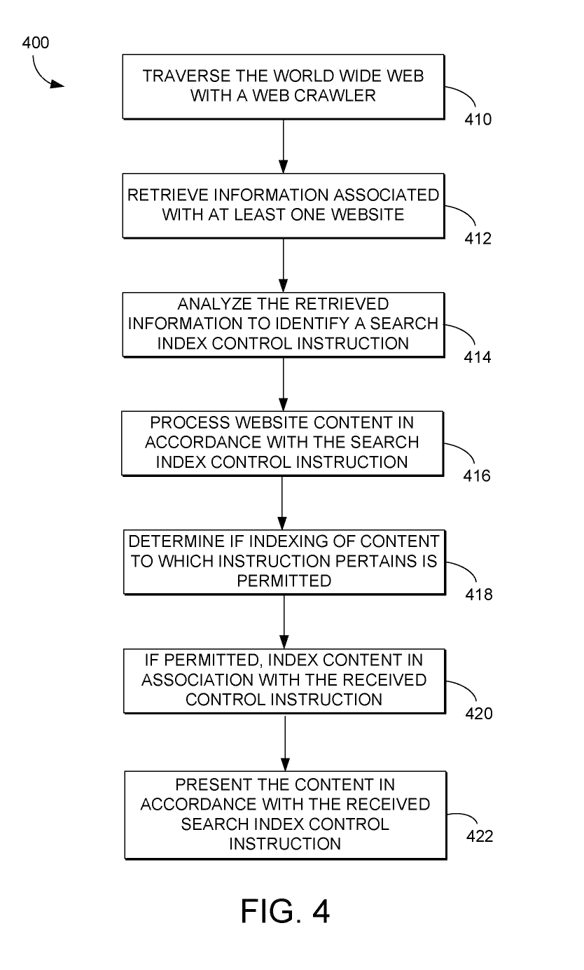

Turning now to FIG. 4, a flow diagram of an exemplary method for controlling search indexing and receiving one or more search index control instructions, in accordance with an embodiment of the present invention, is illustrated and designated generally as reference numeral 400. Initially, as indicated at block 410, the web is traversed, for instance, with a robot such as a web crawler. Next, as indicated at block 412, information associated with at least one website is retrieved and, as indicated at block 414, the retrieved information is analyzed in order to identify a search index control instruction associated with the website. As discussed above, in various embodiments, the instruction may be included as part of a robots.txt file associated with the website, the instruction may be included in the source code of the website itself, or the instruction may be included in the sitemap of the website. For example, without limitation, the source code might be included in the HTML code associated with the website.

Next, as indicated at block 416, website content is processed in accordance with the search index control instruction as previously discussed with reference to FIG. 3. Subsequently, as indicated at block 418, the identified search index control instruction is analyzed to determine if indexing of the content to which it pertains is permitted. If indexing is not permitted, the content associated with the identified search index control instruction is not indexed. However, if it is determined that indexing of the content to which the identified search index control instruction pertains is permitted, such content is indexed, as indicated at block 420, and stored, e.g., in database 202 of FIG. 2, in association with the search index control instruction(s) pertaining thereto. Subsequently, upon receipt of an appropriate query or instruction (and only if such is permitted in accordance with the identified search index control instruction) the indexed content may be presented (for instance, utilizing presentation component 210 of FIG. 2). This is indicated at block 422.

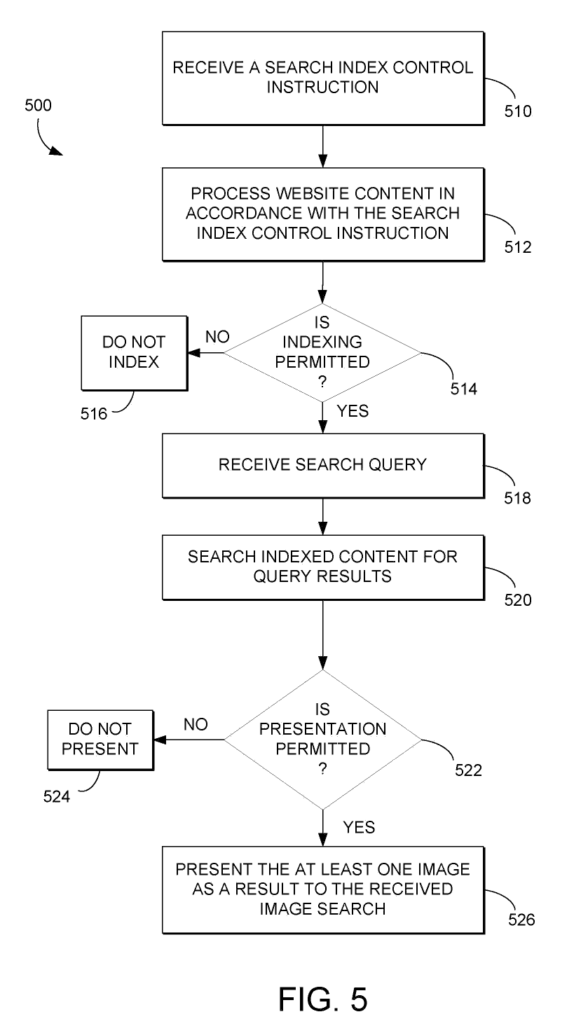

Turning now to FIG. 5, a flow diagram of an exemplary method for controlling search indexing and receiving one or more search index control instructions, in accordance with an embodiment of the present invention, is illustrated and designated generally as reference numeral 500. Initially, as indicated at block 510, a search index control instruction is received, e.g., by receiving component 212 of FIG. 2. In one embodiment, more than one search index control instructions are received and the instructions may be different from one another and/or pertain to content associated with different portions of a website. Next, as indicated at block 512, website content is processed in accordance with the search index control instruction. By way of example, an image, video file, multimedia file, audio file, or other information may be prepared for indexing and modified presentation on or accessed by another website.

Next, as indicated at block 514, it is determined (for instance, utilizing determining component 214 of FIG. 2) whether indexing of the content associated with the search index control instruction is permitted. If it is determined that indexing is not permitted, such content is not indexed and will not be returned in response to a search query, as more fully described below. This is indicated at block 516. If, however, it is determined that indexing is permitted, such content and the associated search index control instruction are stored until receipt of a search query satisfied thereby.

Next, as indicated at block 518, a search query is received, e.g., by query receiving component 218 of FIG. 2. For example, without limitation, an image search query may be input by a user into a image search engine and the image search may be a word or phrase designed to elicit images from the image search engine associated with the word or phrase. For instance, a user of a computing device might input the image search “mountains” in order to retrieve links to images of mountains.

Subsequently, the indexed content is searched (for instance, utilizing searching component 220 of FIG. 2), as indicated at block 520 to determine if any indexed content satisfies the search query. If it is determined that no indexed content satisfies the query, a message indicating such may be returned to the user and displayed, for example, utilizing presentation component 210 of FIG. 2, if desired. If, however, it is determined that one or more of the indexed content items satisfies the search query, it is next determined whether, in accordance with any search index control instructions pertaining to the satisfying content, presentation of the indexed content is permitted. This is indicated at block 522. If presentation is not permitted, such content is disregarded as a search result. This is indicated at block 524. If, however, it is determined that presentation is permitted, the query-satisfying content is presented (e.g., displayed), as indicated at block 526. By way of example, an image with a mountain, or an image with the term “mountain” in its title may be determined for presentation in response to the query set forth herein above.

In each of the exemplary methods described herein, various combinations and permutations of the described blocks or steps may be present and additional steps may be added. Further, one or more of the described blocks or steps may be absent from various embodiments. It is contemplated and within the scope of the present invention that the combinations and permutations of the described exemplary methods, as well as any additional or absent steps, may occur. The various methods are herein described for exemplary purposes only and are in no way intended to limit the scope of the present invention.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain the ends and objects set forth above, together with other advantages which are obvious and inherent to the methods, computer-readable media, and graphical user interfaces. It will be understood that certain features and sub-combinations are of utility and may be employed without reference to other features and sub-combinations. This is contemplated by and within the scope of the claims.

The invention claimed is:

1. One or more computer readable media having instructions embodied thereon that, when executed, perform a method for controlling search indexing, the method comprising:
receiving a search index control instruction pertaining to website content; and
processing the website content in accordance with the received search index control instruction, wherein processing the website content includes preparing the website content for indexing and modified presentation thereof.

2. The one or more computer readable media of claim 1, wherein the search index control instruction includes an exclusionary instruction, and wherein the exclusionary instruction includes at least one domain excluded from linking to the website content.

3. The one or more computer readable media of claim 1, wherein the website content includes at least one image.

4. The one or more computer readable media of claim 3, wherein the search index control instruction includes an instruction to present specified text in association with the at least one image upon indexing and presentation thereof.

5. The one or more computer readable media of claim 3, wherein the search index control instruction includes a modification instruction, and wherein the modification instruction includes at least one of an instruction to display the at least one image as a thumbnail of a larger image, an instruction to display the image with a border on one or more sides thereof, and an instruction to display the image with a string of characters superimposed there over.

6. The one or more computer readable media of claim 1, wherein the website content includes at least one multimedia file.

7. The one or more computer readable media of claim 1, wherein the website content includes at least one audio file.

8. The one or more computer readable media of claim 1, further comprising:
determining if the search index control instruction allows indexing of the content to which it pertains,
wherein if it is determined that the search index control instruction allows indexing, the method further comprises indexing the content to which the search index control instruction pertains in accordance with the search index control instruction.

9. The one or more computer readable media of claim 1, wherein the method further comprises determining if the search index control instruction allows presentation of the content to which it pertains.

10. The one or more computer readable media of claim 9,
wherein if it is determined that the search index control instruction allows presentation, the method further comprises presenting the content to which the search index control instruction pertains in accordance with the search index control instruction.

11. The one or more computer readable media of claim 1, wherein receiving a search index control instruction comprises:
traversing the Internet with a web crawler;
retrieving information associated with at least one of a robots.txt file and source code associated with the website; and
analyzing the retrieved information to locate the respective search index control instruction.

12. A computerized system for controlling search indexing, the system comprising:
a receiving component configured to receive at least one search index control instruction;
a determining component configured to analyze the at least one received search index control instruction to determine if indexing of content associated therewith is permitted;
an indexing component configured to index content associated with the at least one search index control instruction if it is determined that indexing thereof is permitted; and
a database for storing the indexed content in association with the received search index control instruction.

13. The system of claim 12, further comprising:
a query receiving component configured to receive at least one search query; and
a searching component configured to search the database for indexed content that satisfies the at least one search query.

14. The system of claim 13, further comprising a presentation component configured to present the indexed content that satisfies the at least one search query in accordance with the associated search index control instruction.

15. A method for controlling search indexing, the method comprising:
receiving a search index control instruction, the search index control instruction pertaining to content associated with at least a portion of a website;
determining, based upon the received search index control instruction, if indexing of the content to which it pertains is permitted; and
if it is determined that indexing of the content to which the received search index control instruction pertains is permitted, indexing the content in accordance with the received search index control instruction.

16. The method of claim 15, further comprising presenting the content in accordance with the received search index control instruction.

17. The method of claim 15, wherein the search index control instruction comprises a site-level instruction configured to apply to all content on the website.

18. The method of claim 15, wherein the search index control instruction comprises a page-level instruction configured to apply to less than all web pages associated with the website.

19. The method of claim 15, wherein the search index control instruction comprises a link-level instruction configured to apply to one or more specified links within a web page associated with the website.

20. The method of claim 15, wherein the search index control instruction is included in a sitemap of a website.
